(19) United States
(12) Patent Application Publication
(10) Pub. No.: US 2013/0170024 A1
(43) Pub. Date: Jul. 4, 2013

(54) OBLIQUE-ILLUMINATION SYSTEMS AND METHODS

(71) Applicants: Kyla Teplitz, Issaquah, WA (US); Carl Brown, Issaquah, WA (US)

(72) Inventors: Kyla Teplitz, Issaquah, WA (US); Carl Brown, Issaquah, WA (US)

(73) Assignee: APPLIED PRECISION, INC., ISSAQUAH, WA (US)

(21) Appl. No.: 13/823,217

(22) PCT Filed: Sep. 14, 2011
(86) PCT No.: PCT/US11/51486

§ 371 Date: Mar. 14, 2013

Related U.S. Application Data
(60) Provisional application No. 61/382,725, filed on Sep. 14, 2010.

(51) Int. Cl. G02B 21/06

(52) U.S. Cl. CPC G02B 21/06
USPC 359/387; 359/385

(57) ABSTRACT

Oblique-illumination systems integrated with fluorescence microscopes and methods of using oblique illumination in fluorescence microscopy are disclosed. An oblique-illumination system is attached to a fluorescence microscope objective. The oblique-illumination system can be used to illuminate from any desired direction the surface of an object located at a fixed known offset away from a sample solution containing fluorescently tagged targets. Oblique illumination is used to illuminate features of the surface while epi-illumination is used to create fluorescent light emitted from the tagged targets. The combination of oblique illumination of the surface and epi-illumination of the targets enables capture of images of the surface features and the fluorescent targets so that the locations of the targets in the sample can be determined based on the locations of the surface features.

### CROSS-REFERENCE TO RELATED APPLICATIONS

This application claims priority to U.S. provisional patent application No. 61/382,725 filed Sep. 14, 2010, the disclosure of which is incorporated herein by reference in its entirety.

### TECHNICAL FIELD

This disclosure relates to microscopy, and, in particular, to imaging systems and methods that use oblique-reflection illumination in combination with fluorescence microscopy.

### BACKGROUND OF THE INVENTION

Capturing robust, automated scanned images of fluorescently tagged targets in sample solutions can be challenging. The images can be used to try to locate the targets for identification, extraction, or isolation. Consider, for example, free-floating fluorescently tagged cells in a sample disposed between a slide and a cover slip. Without a method or reference point that can be used to determine the three-dimensional location of the tagged cells, it may be difficult to image and perform further analysis on the cells.

Conventional methods for locating fluorescent targets in a sample often involve a combination of mechanical and optical techniques. For example, one technique for locating targets in a sample includes assigning one edge of a slide as a reference and using the known distance from the edge to the cover slip to define scan regions between the cover slip and slide. However, factors such as manufacturing tolerances, target size, density, and variability in mounting techniques, create uncertainty about the precise location of the target within a region. Other techniques include fluorescent scanning, bright field imaging and reflection. However, these techniques have a number of disadvantages. With fluorescence scanning, the fluorescent signature of the target can be used to search for the target, but the fluorescent signature of the target alone may not be sufficient to determine the location of the target, because signals and contrast due to signal intensity vary from sample to sample, the signal intensity can vary over time, or the background can vary. Also, extended fluorescence imaging can damage the target making it undesirable to use fluorescence imaging for target finding prior to experimental imaging. With bright field imaging, expensive optics and a different light path are often required to gain high contrast images. In some cases, the quality of the fluorescent images may be compromised because a number of the optical components are located in the fluorescent imaging pathway. With reflection imagining in an epi-fluorescent system, it is often difficult to get the same wavelength from the illumination source to the detector. Epi-fluorescent systems typically have an illumination source that illuminates fluorescent tags at a short wavelength, which stimulates emission of longer wavelengths from the fluorescent tags. Dichroic minors reflect the illumination wavelengths and pass the emission wavelengths. As a result, the illumination source is configured to emit the same wavelengths as the light to be emitted from the fluorescent targets, or an emission pathway is included to pass illumination wavelengths. Either option may require additional components that add cost and complexity to the system. Additionally, epi-reflection imaging provides images of the first surface illuminated by the objective which is typically the front of the coverslip or a slide. This location may not have the high contrast needed for focusing and may not be a useful reference for locating the sample. For the above described reasons, engineers, scientists, and microscope manufacturers continue to seek systems and methods to find the location of fluorescent targets for imaging.

### SUMMARY OF THE INVENTION

This disclosure is directed to oblique-illumination systems integrated with fluorescence microscopes and to methods of using oblique illumination in fluorescence microscopy. An oblique-illumination system can be attached to a fluorescence microscope objective. The oblique-illumination system is used to illuminate from any desired direction the surface of an object located at a fixed known offset away from a sample solution containing fluorescently tagged targets. Oblique illumination is used to illuminate features of the surface while epi-illumination is used to create fluorescent light emitted from the tagged targets. The combination of oblique illumination of the surface and epi-illumination of the targets enables capture of images of the surface features and the fluorescent targets so that the locations of the targets in the sample can be determined based on the locations of the surface features.

### DETAILED DESCRIPTION OF THE DRAWINGS

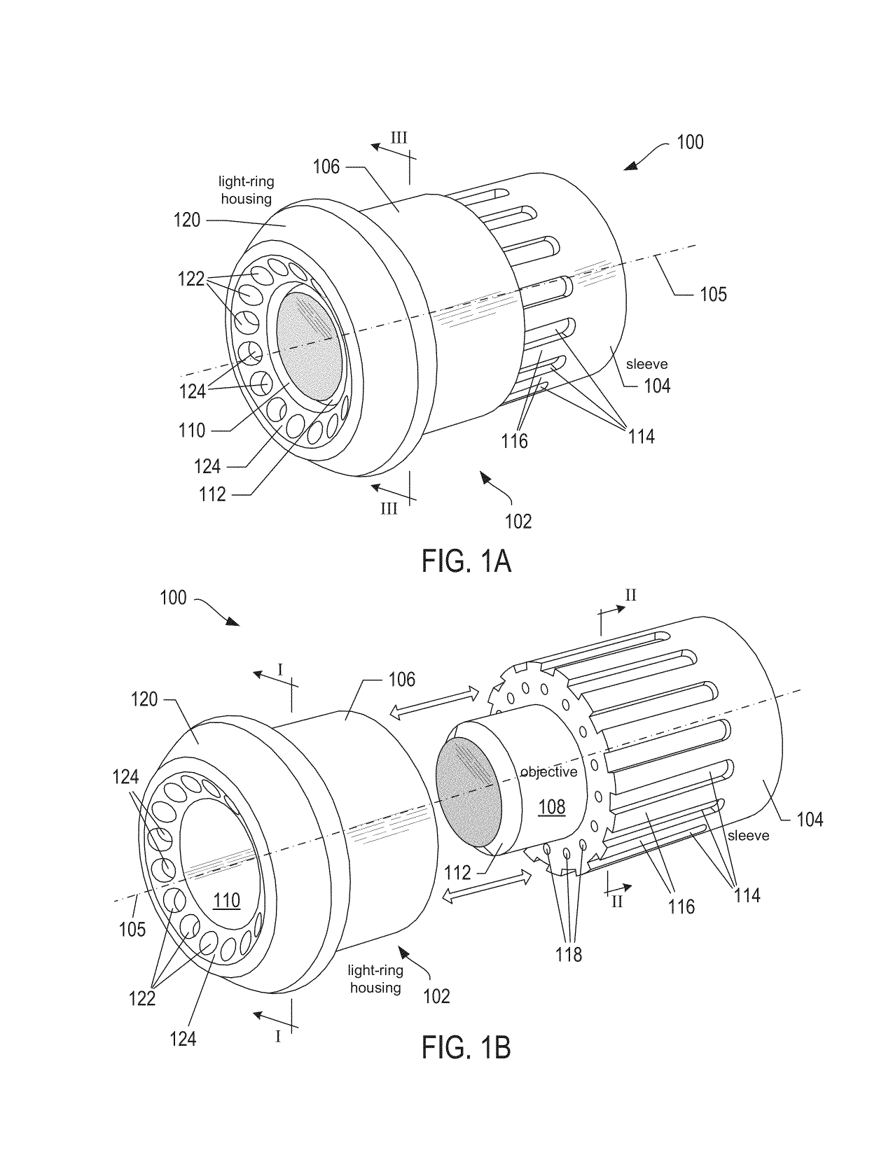

FIGS. 1A-1B show perspective views of an example oblique-illumination system.

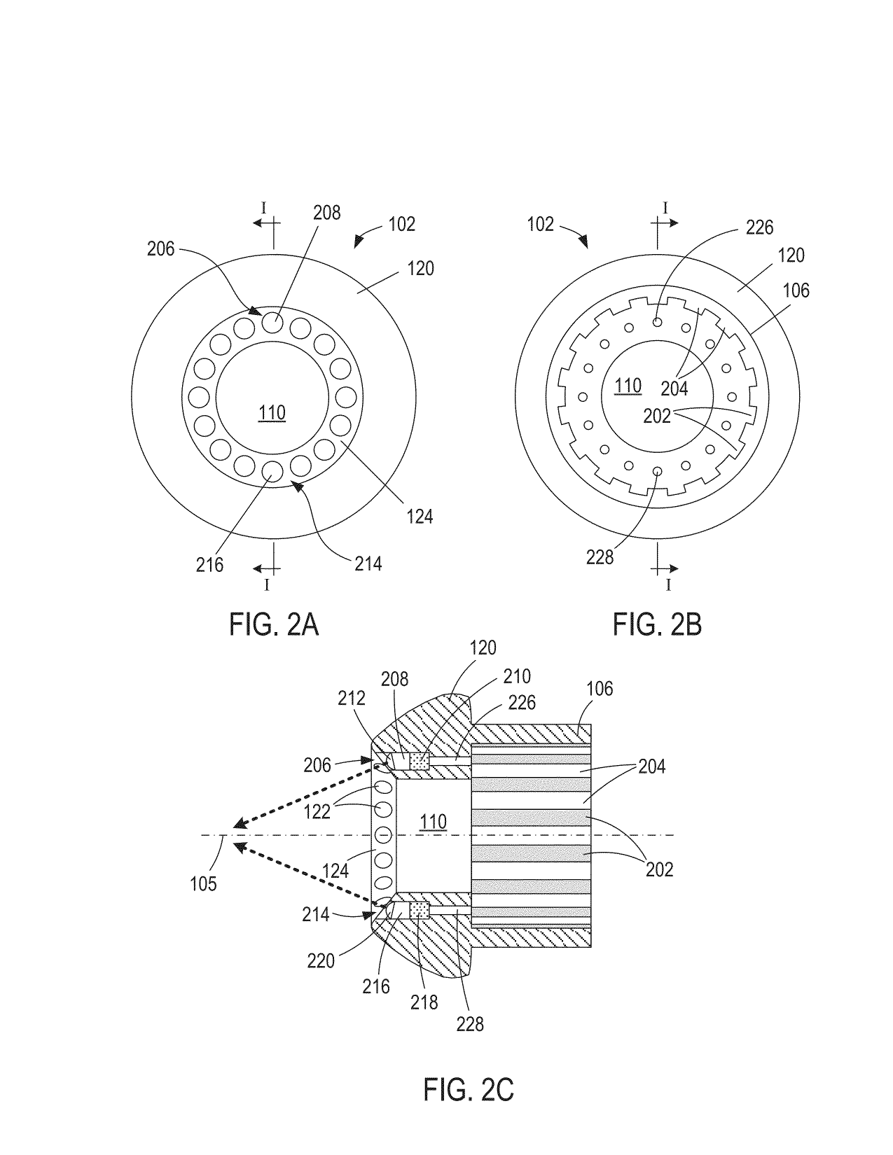

FIGS. 2A-2C show front and back views, respectively, of an oblique-illumination system housing.

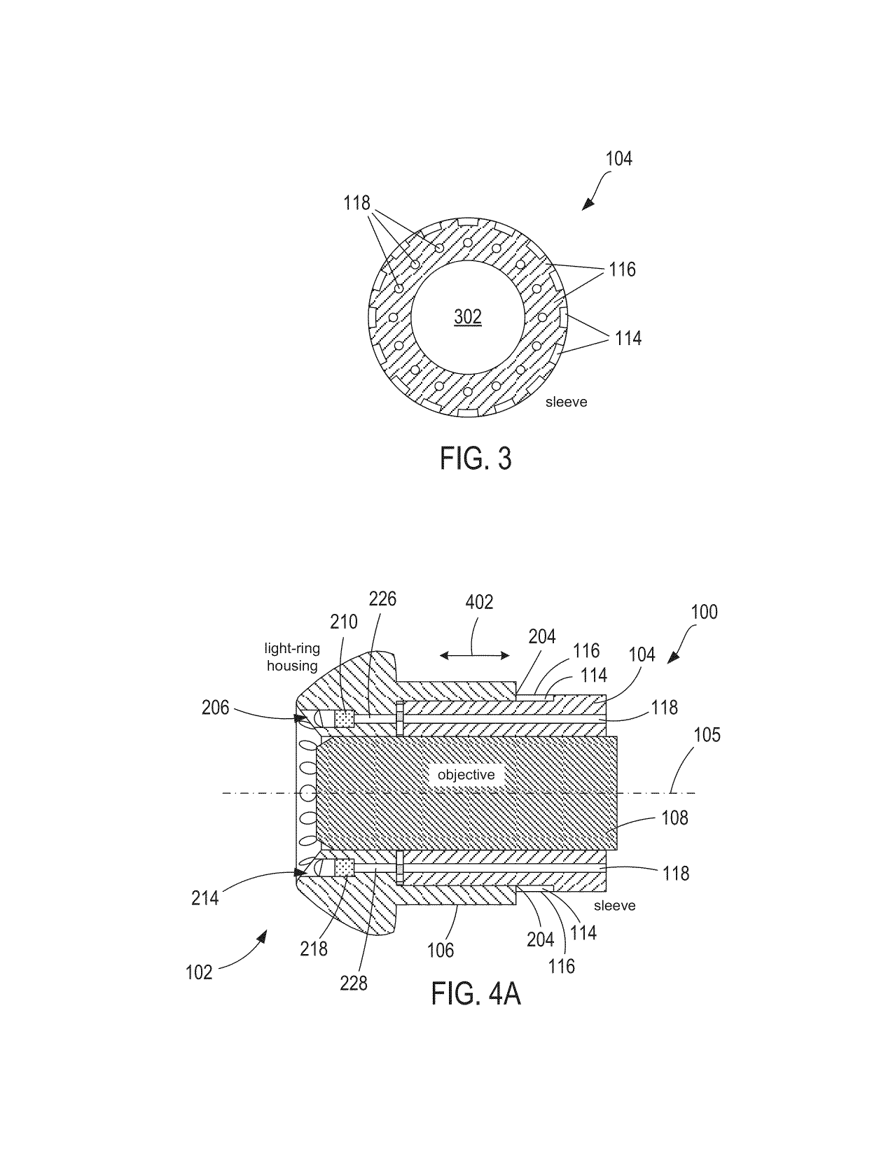

FIG. 3 shows a cross-sectional view of an oblique-illumination system sleeve.

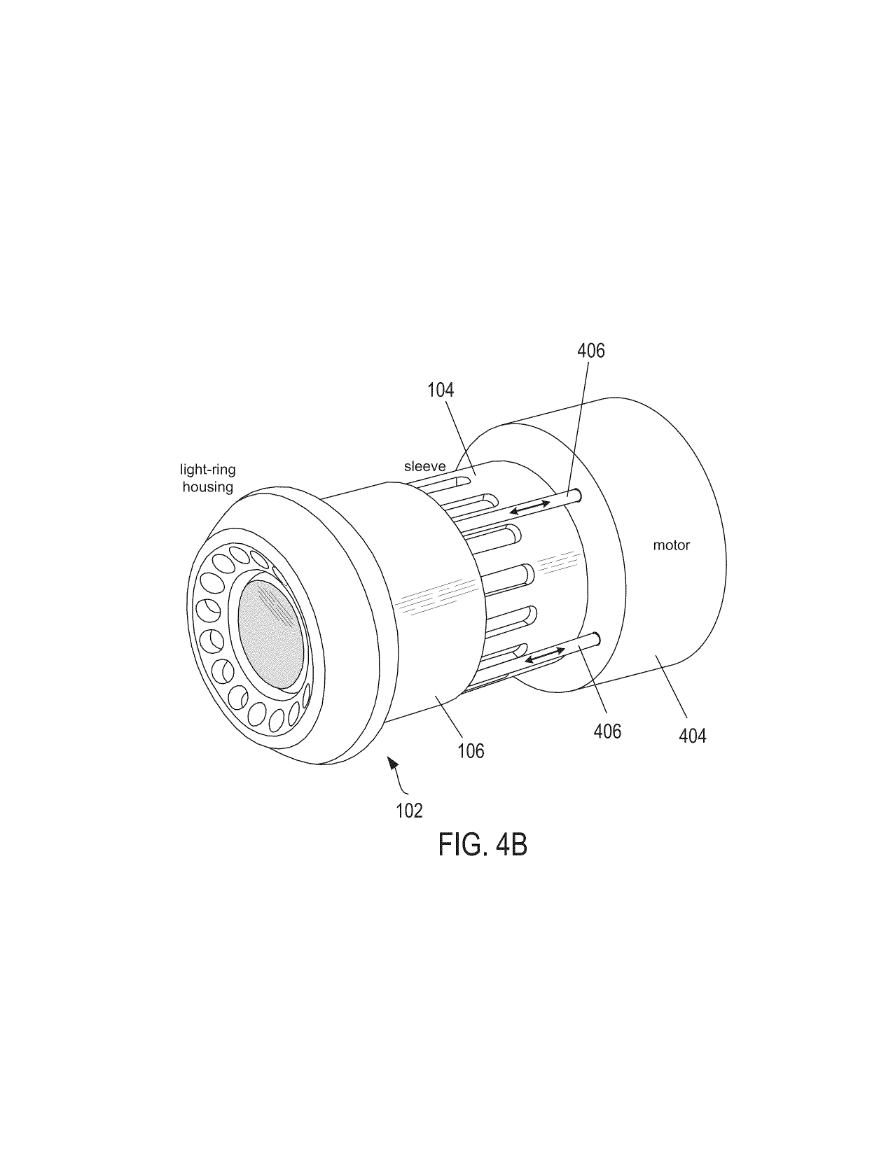

FIG. 4A shows a cross-sectional view of an oblique-illumination system.

FIG. 4B shows a perspective view of a motor attached to a oblique-illumination system.

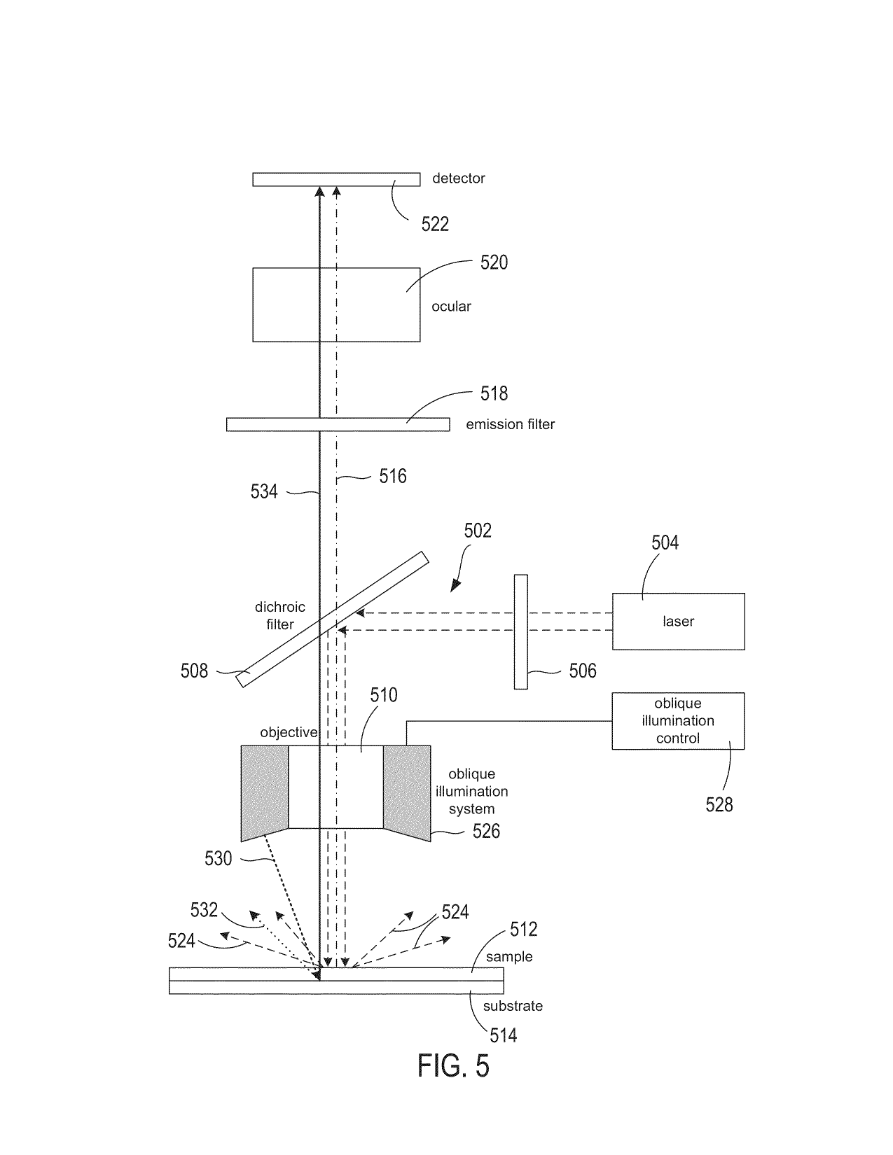

FIG. 5 shows optical paths within an epi-fluorescence microscope that includes an oblique-illumination system.

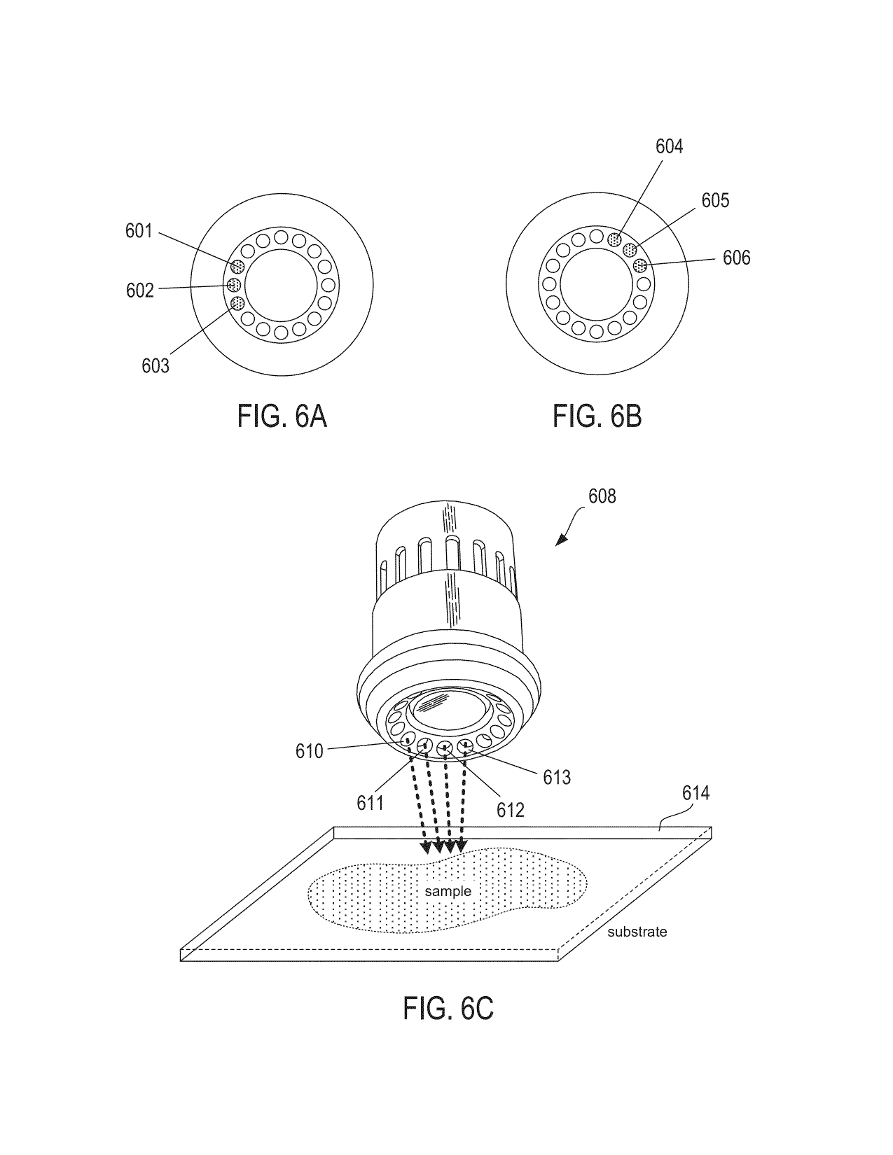

FIGS. 6A-6C show front views of a light-ring housing with two different sets of oblique-illumination lights activated.

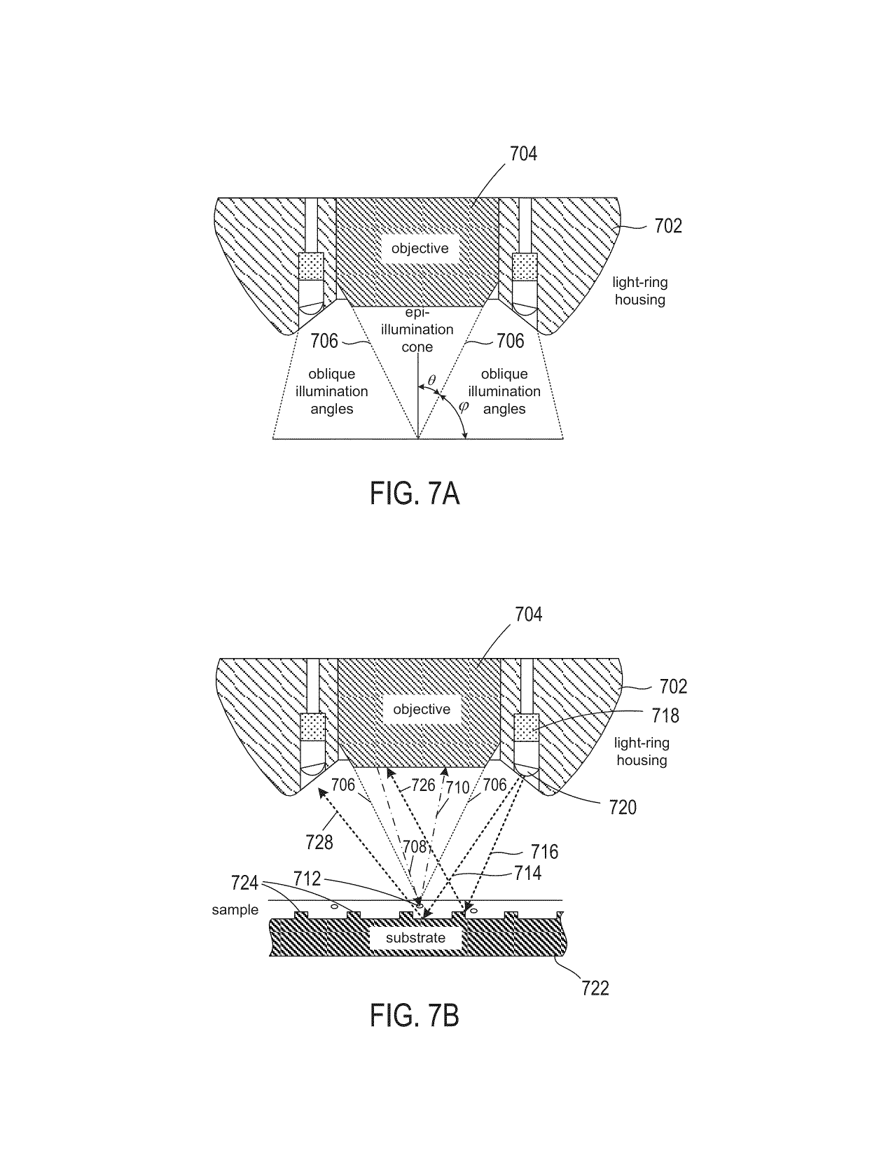

FIGS. 7A-7B show cross-sectional views of a light-ring housing of an oblique-illumination system and an objective of an epi-fluorescence microscope.

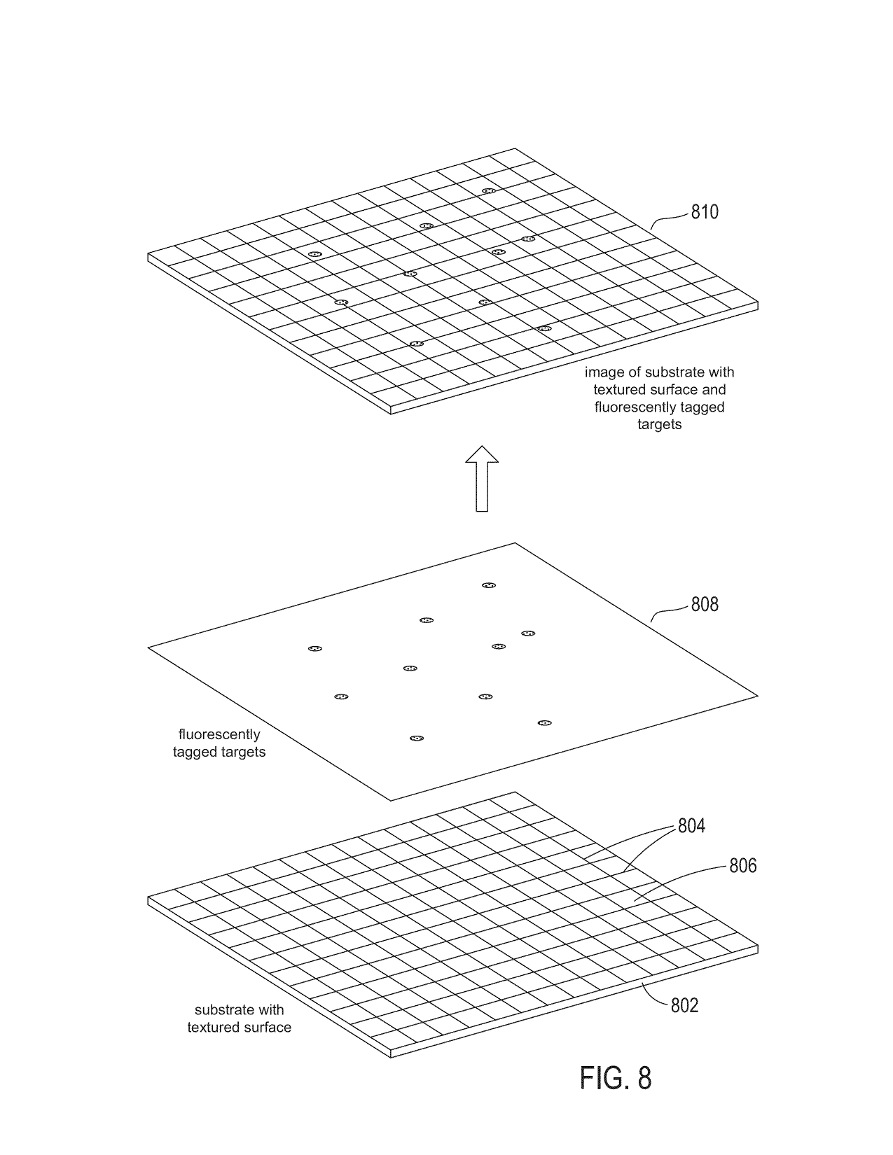

FIG. 8 shows an example of images of a substrate and fluorescently tagged targets of a sample solution.

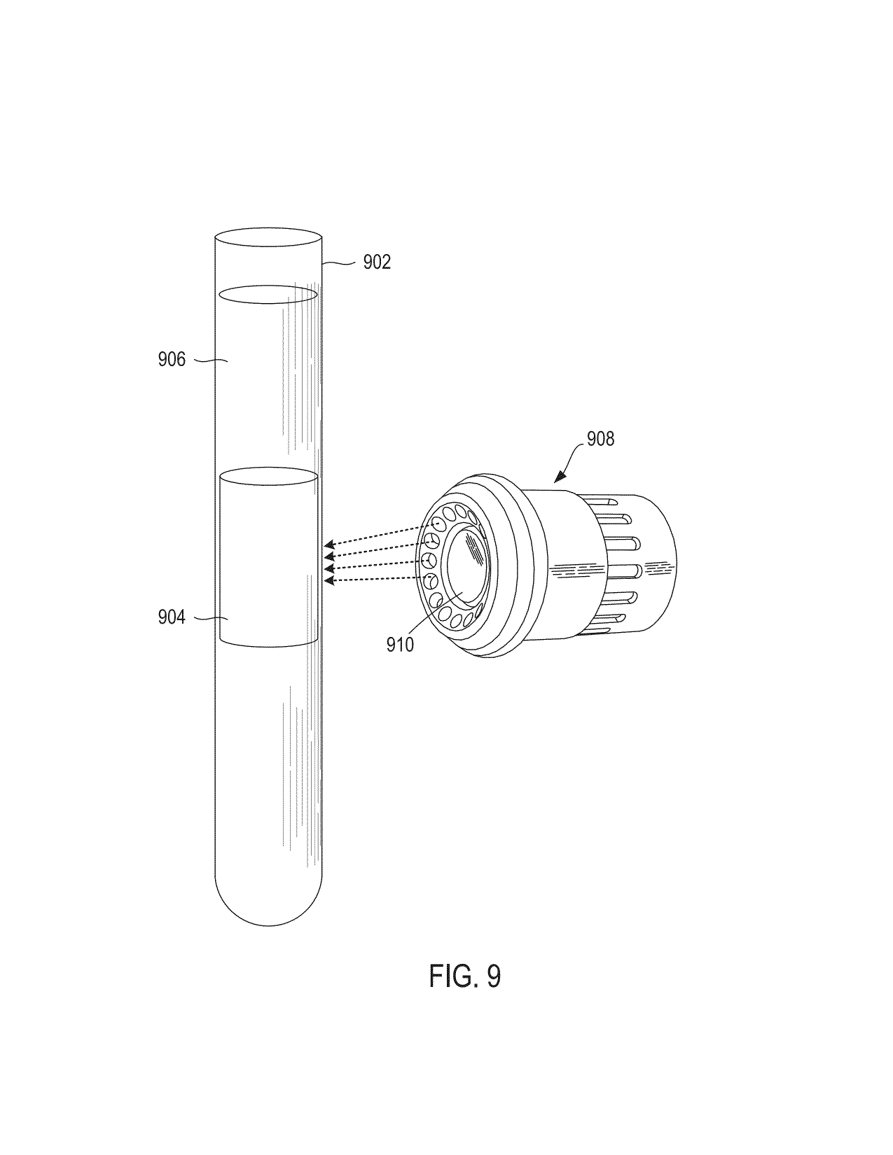

FIG. 9 shows an example of a tube and a cylindrical object that floats within a sample solution contained in the tube.

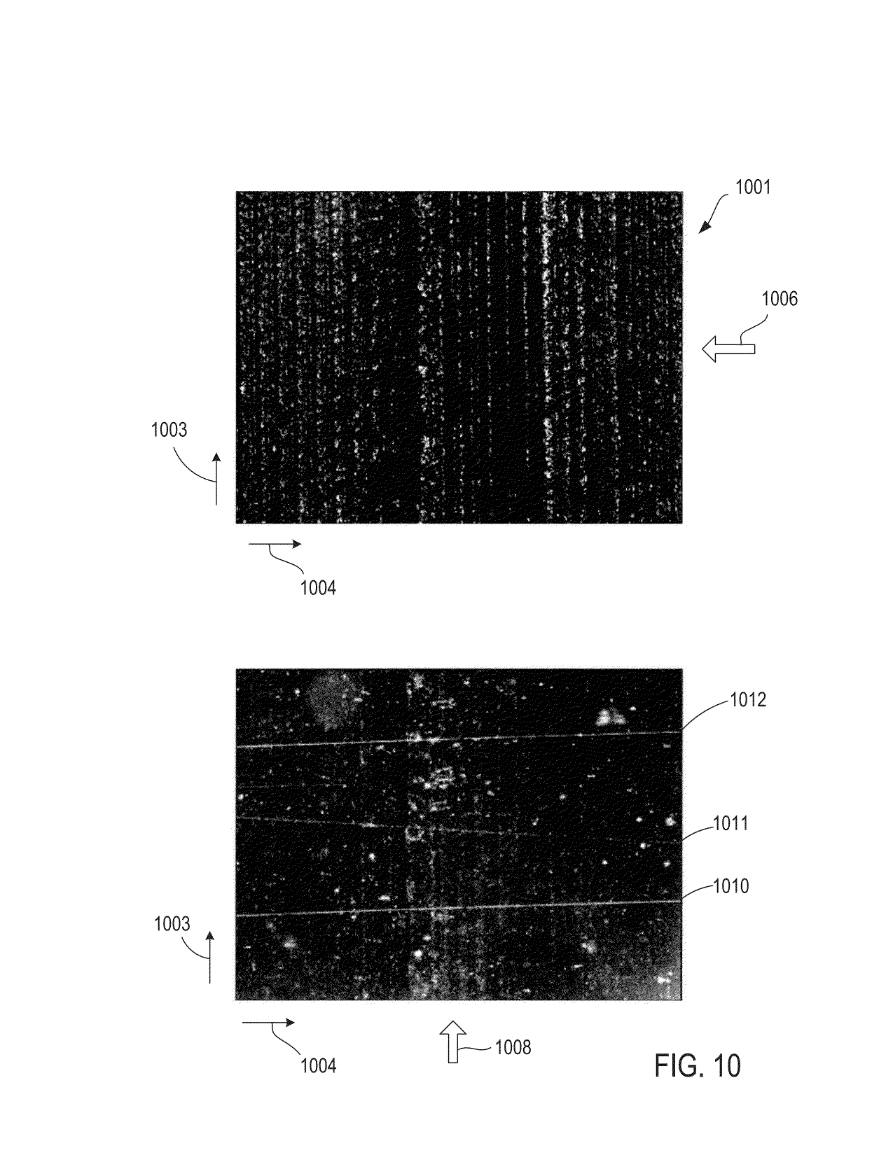

FIG. 10 shows two images of a cylindrical object floating in a tube using an oblique-illumination system.

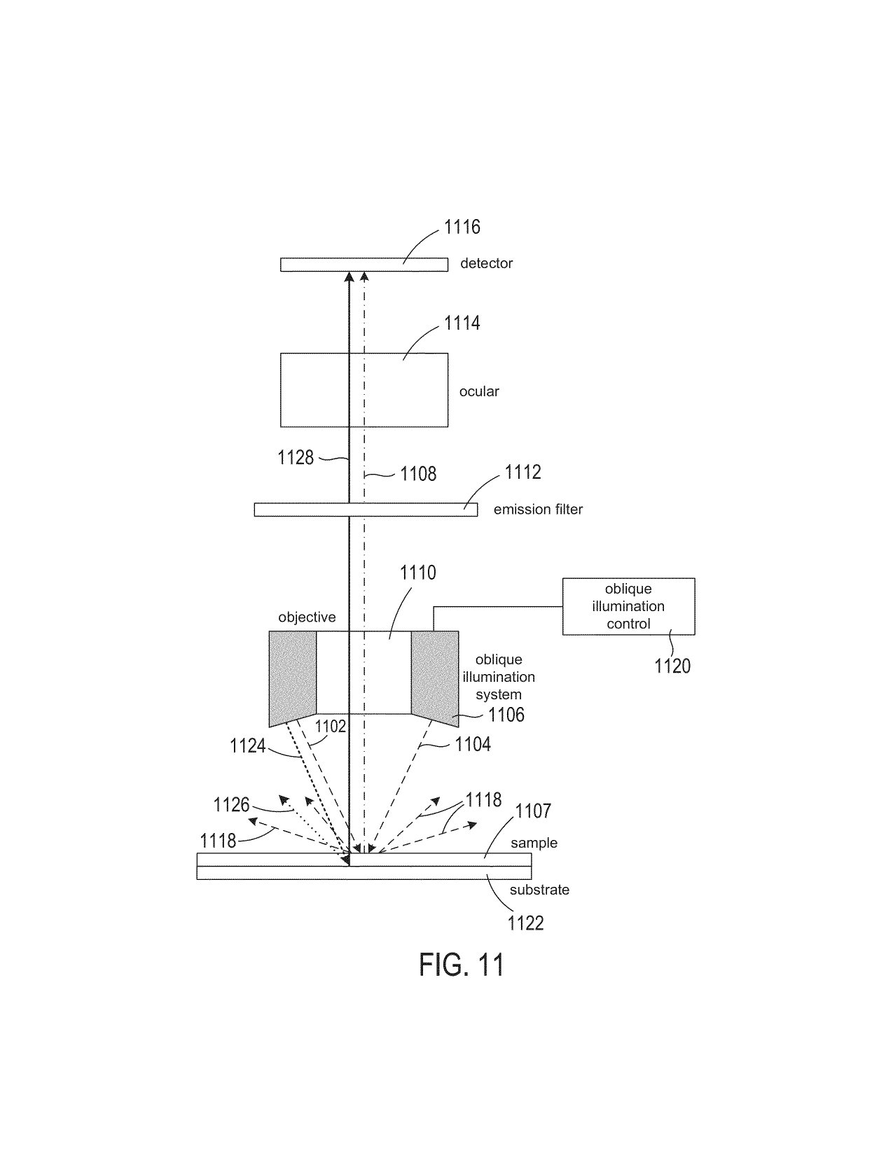

FIG. 11 shows optical paths within a fluorescence microscope where excitation light is provided by excitation-light sources in an oblique-illumination system.

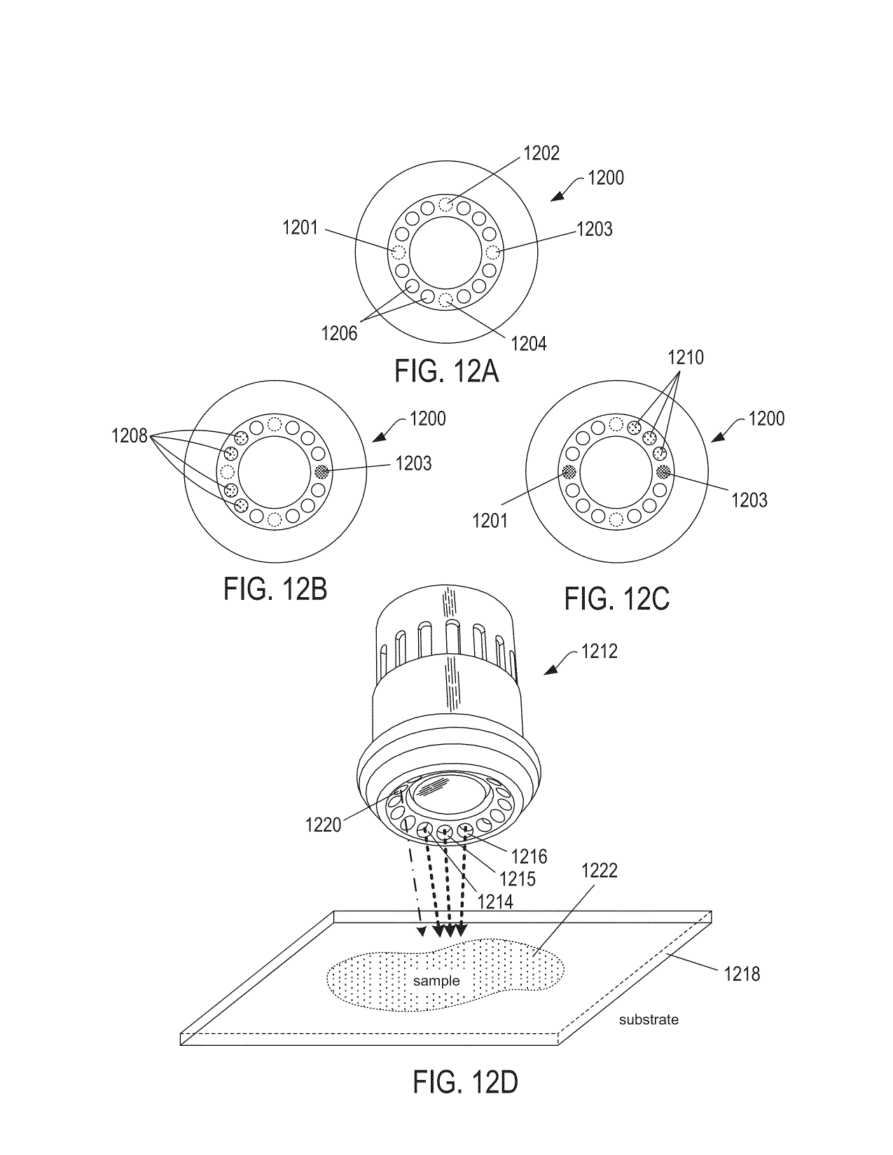

FIG. 12A shows a front view of a light-ring housing with four excitation-light sources.

FIGS. 12B-12C show front views of a light-ring housing with two different sets of excitation-light sources and oblique-illumination lights activated.

FIG. 12D shows a perspective view of an oblique-illumination system with oblique-illumination lights and an excitation-light source activated.

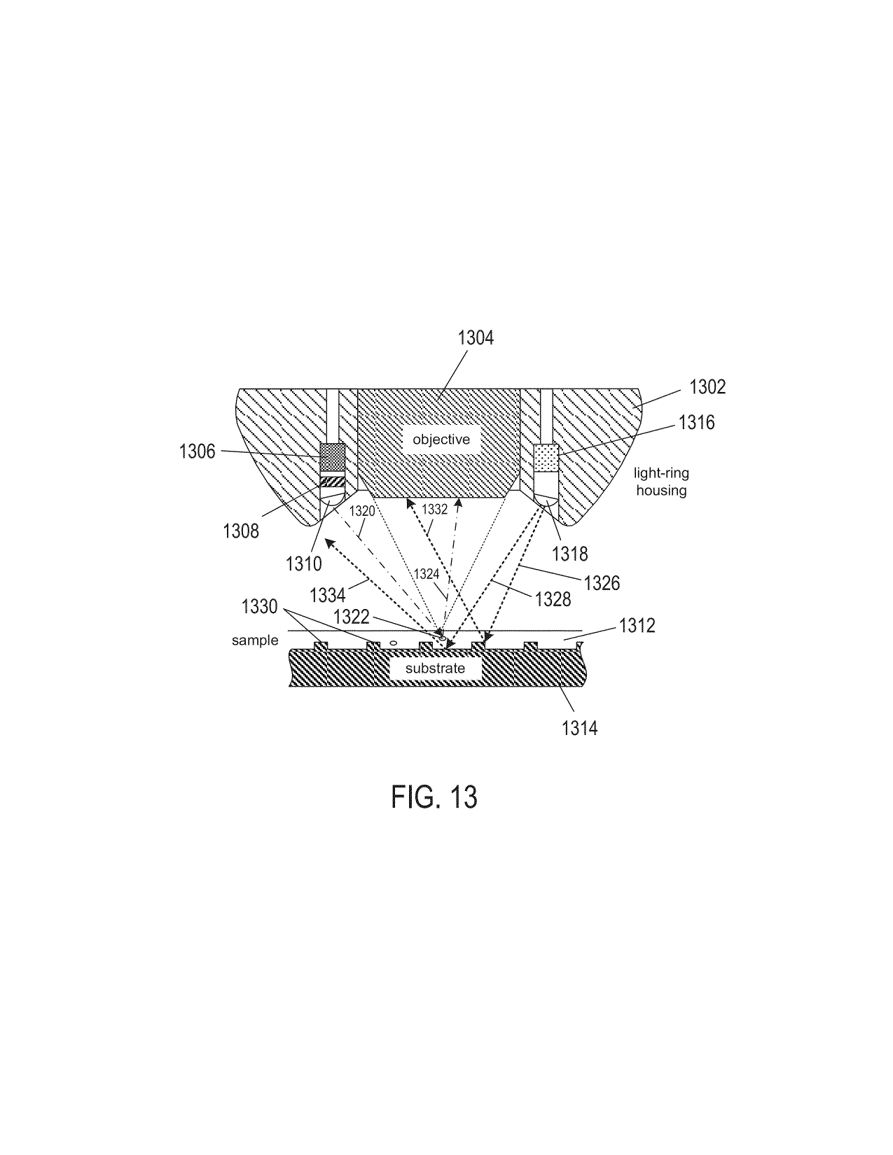

FIG. 13 shows a cross-sectional view of a light-ring housing of an oblique-illumination system and an objective of a fluorescence microscope.

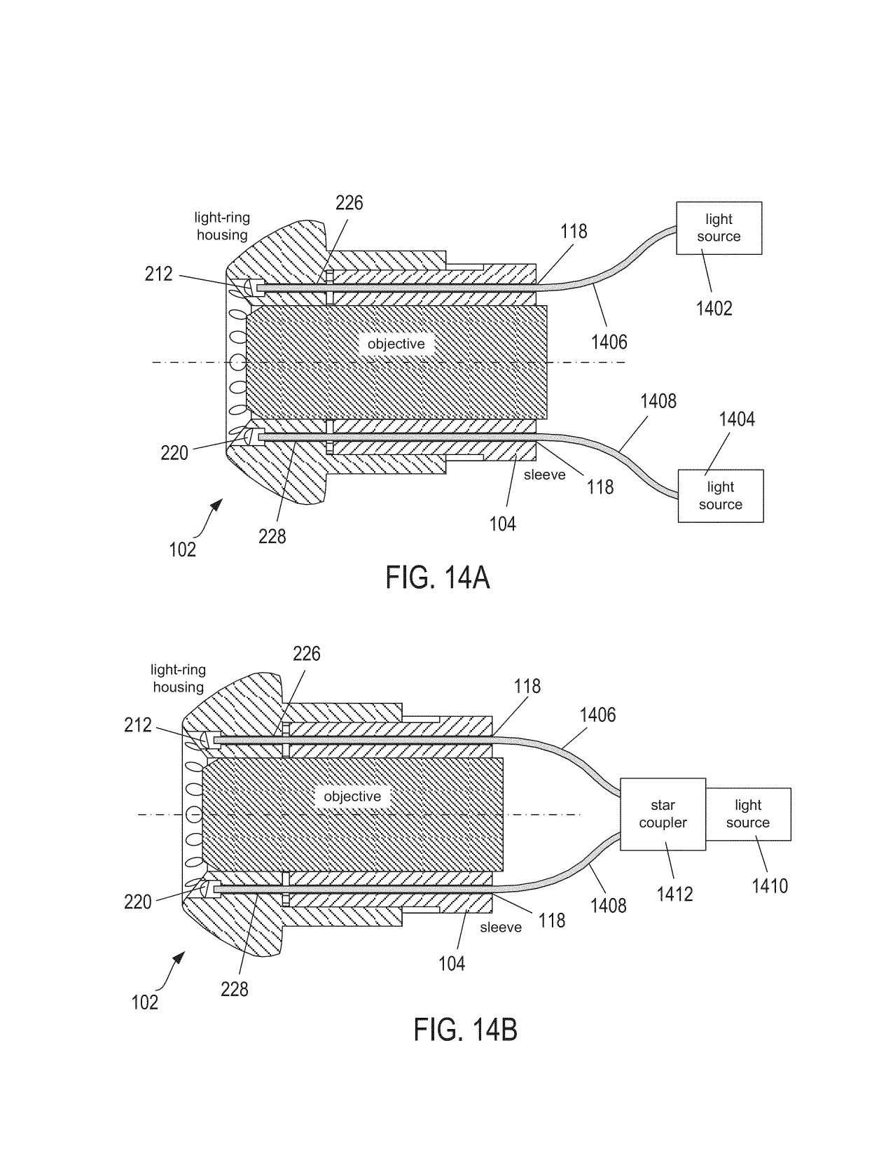

FIGS. 14A-14B show cross-sectional views of oblique-illumination systems with light sources located outside a housing.

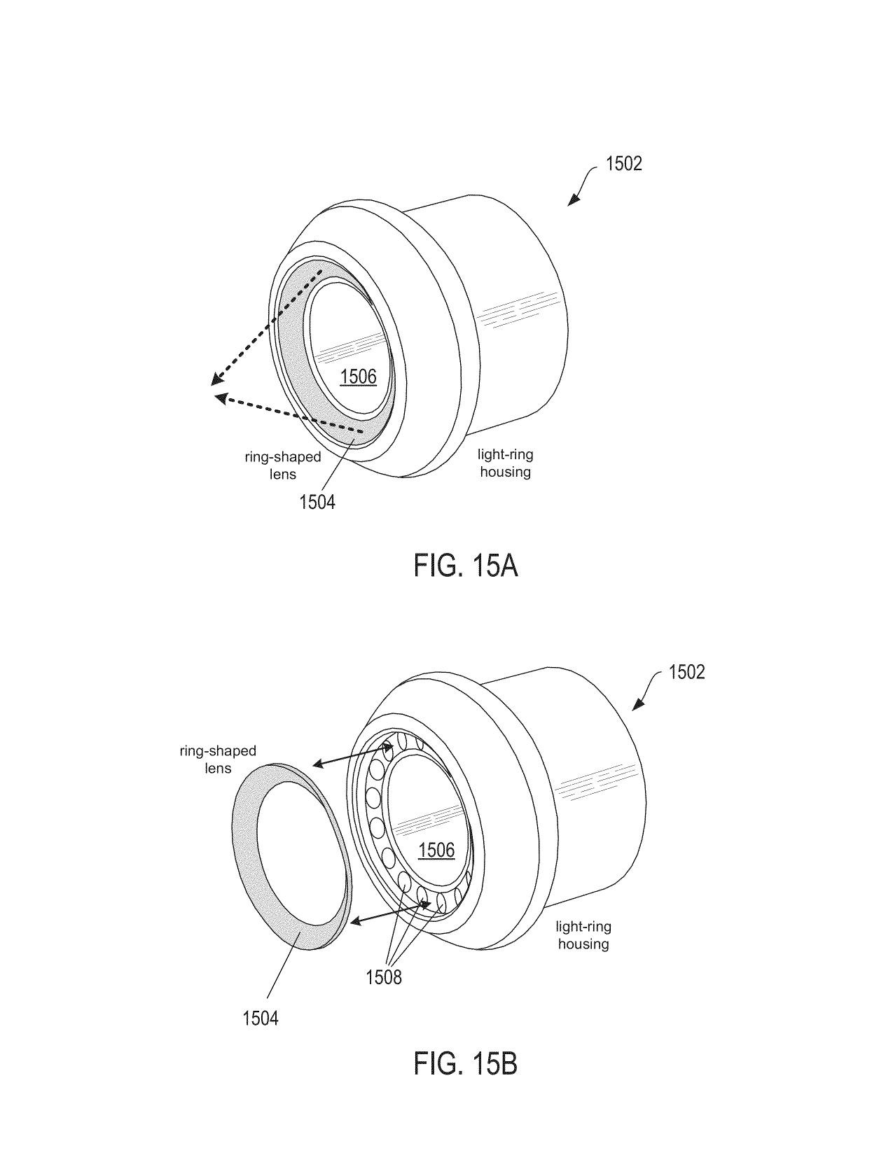

FIGS. 15A-15B show perspective views of a housing with a ring-shaped lens.

### DETAILED DESCRIPTION OF THE INVENTION

FIGS. 1A-1B show perspective views of an example oblique-illumination system 100. The system 100 includes a light-ring housing 102 and an objective sleeve 104. The light-ring housing 102 and sleeve 104 are cylindrical and are shown in FIGS. 1A-1B as sharing a common cylindrical axis 105. FIG. 1A shows a perspective view of the sleeve 104 inserted into a cylindrical shell 106 of the housing 102. FIG. 1B shows the sleeve 104 removed from the cylindrical shell 106 and a microscope objective 108 inserted into a cylindrical opening of the sleeve 104 and reveals a cylindrical opening 110 in the housing 102, which is dimensioned to receive the objective 108 so that when then sleeve 104 is inserted into the cylindrical shell 106 of the housing 102, as shown in FIG. 1A, front lens assembly 112 of the objective 108 is exposed. The optical axis of the objective 108 corresponds to the common cylindrical axis 105 of the housing 102 and sleeve 104. FIGS. 1A-1B show a number of radially-spaced, axially-oriented grooves 114 that form guides 116 in the exterior cylindrical surface. The grooves 114 and guides 116 are dimensioned to receive corresponding radially-spaced guides and grooves (not shown) located around the inner surface of the cylindrical shell 106, as described in greater detail below. The sleeve 104 also includes a number of radially-spaced, axially-oriented holes 118 that span the cylindrical height of the sleeve 104. The housing 102 includes a toroidal or donut-shaped end 120. The toroidal-shaped end 120 surrounds a portion of the cylindrical opening 110 and includes a number of radially-spaced, axially-oriented holes 122 formed in a circular surface 124 that surrounds and is angled toward the opening 110. Each hole 122 includes a light source (not shown) and a lens, such as lenses 124, to form an oblique-illumination light. Each hole 122 in the housing 102 is aligned with a hole 118 in the sleeve, as described in greater detail below.

FIGS. 2A-2B show front and back views, respectively, of the housing 102. In the front view of FIG. 2A, the housing 120 includes 16 holes 122 formed in the angled surface 124 surrounding the opening 110. The back view of FIG. 2B reveals a number of radially-spaced, axially-oriented grooves 202 in the inner surface of the cylindrical shell 106 of the housing 102. Each pair of grooves is separated by a guide 204. The guides 204 and grooves 202 of the cylindrical shell 106 are dimensioned to receive the grooves 114 and guides 116 of the sleeve 104, as shown in FIGS. 1A-1B. FIG. 2C shows a cross-sectional view of the housing 102 along a line I-I shown in FIGS. 1B and 2A-2B. This cross-sectional view shows an example of two holes surrounding the opening 110 and reveals that each hole has a large diameter portion in which light sources and focusing lenses are disposed. For example, a hole 206 includes a large diameter portion 208 in which a light source 210 and a focusing lens 212 are disposed, and a hole 214 includes a large diameter portion 216 in which a light source 218 and a focusing lens 220 are disposed. The light sources can be light-emitting diodes (“LEDs”) or semiconductors lasers, such as edge-emitting lasers or vertical-cavity surface-emitting lasers. Each light source and corresponding lens forms an oblique-illumination light that directs light emitted from the source toward the optical axis 105. For example, lenses 212 and 220 are plano-convex lenses positioned to focus the light emitted from light sources 210 and 218, respectively, toward optical axis 105, as indicated by directional arrows 222 and 224. The cross-sectional view of FIG. 2C also reveals that each hole has a smaller diameter portion that leads from the large diameter portion to the interior space of the cylindrical shell 106. For example, holes 206 and 208 include smaller diameter portions 226 and 228 that reach the interior space of the cylindrical shell 106. The smaller diameter portions of the holes 122 appear as radially spaced holes surrounding the opening 110 in FIG. 2B.

FIG. 3 shows a cross-sectional view of the sleeve 104 along a line II-II shown in FIG. 1B. This cross-sectional view shows the holes 118 radially-spaced around a cylindrical opening 302 dimensioned to receive the objective 108, as shown in FIG. 1B. The radially-spaced holes 118 are aligned with the holes 122 in the housing 102. FIG. 3 also reveals the radially-spaced guides 116 separated by grooves 114.

FIG. 4A shows a cross-sectional view of the system 100 along a line III-III shown in FIG. 1A with the objective 108 disposed in the cylindrical openings 110 and 302 of the housing 102 and sleeve 104, respectively. As shown in FIG. 4A, small diameter portions 226 and 228 of holes 206 and 214 are aligned with two openings 118 in the sleeve 104. The holes in the housing and the sleeve are aligned to allow wires (not shown) to connect to the light sources so that each light source can be separately controlled. FIG. 4A also shows guides 204 of the housing 102 in the grooves 114 of the sleeve 104. The axially oriented interlocking guides and grooves allow the housing 102 to slide back and forth along the cylindrical axis 105 of the system 100, as indicated by direction arrow 402. The position of the housing with respect to the objective 108 can be adjusted by manually sliding the housing 102 relative to the fixed position of the sleeve 104 in the direction 402 in order to keep the light emanating from the lens from entering the epi-illumination cone of the objective described in greater detail below. Alternatively, a drive motor can be attached to the housing 102 to slide the housing 102 back and forth along the sleeve 104. FIG. 4B shows a perspective view of an example motor 404 attached to the oblique-illumination system 100. The motor 404 includes arms 406 attached to the base of the cylindrical sell 106 of the housing 102. The housing 102 position of the housing 102 with respect to the sleeve 104 is controlled by the motor 404, which controls the axial position of the housing 102 by applying an appropriate force to the arms 406.

The illumination system 100 can be used in conjunction with a fluorescence microscope to determine the location of fluorescently tagged targets of a sample with respect to a background. Fluorescence microscopy methods and instrumentation have been developed to address certain imaging problems associated with traditional optical microscopy, and fluorescence microscopy has been significantly advanced by the discovery and exploitation of various biological and chemical fluorophores. A fluorophore is a functional group of a molecule that absorbs excitation light with wavelengths in a certain wavelength range of the electromagnetic spectrum and emits light at a specific longer wavelength. The amount and wavelength of the emitted light depends on the type of fluorophore and the chemical environment of the fluorophore. For example, Texas Red (i.e., sulforhodamine 101 acid chloride) fluoresces at about 615 nm when excited in solution by excitation light in the range of about 595 nm to about 605 nm. In fluorescence microscopy, the targets of a sample are tagged with particular fluorophores and the sample is illuminated with excitation light that causes fluorescence or phosphorescence of the fluorophores attached to the targets. The light emitted by the fluorophore is then detected through the microscope objective.

FIG. 5 shows the optical path within an epi-fluorescence microscope. There are many different types of fluorescence microscopes and corresponding optical paths. FIG. 5 is not intended to describe the optical paths within all the different, well-known variations of fluorescence microscopes, but to instead illustrate the general principals of fluorescence microscopy. With an epi-fluorescence microscope excitation and collection of the fluorescent emissions are from above (epi-) the sample. Excitation light 502 is emitted from a light source, such as a laser 504, and passes through an excitation-light filter 506. The excitation light is reflected from a diagonal, dichroic minor 508 through the objective lens or lenses 510 onto a sample 512 disposed on a substrate 514. The excitation light causes fluorophores attached to targets within the sample to emit fluorescent light, as discussed above. The emitted fluorescent light, shown in FIG. 5 by dot-dash arrows 516, passes through the objective lens or lenses 510, is transmitted through the dichroic mirror 508, passes through an emission filter 518 and ocular 520 to the image plane of a detector 522. The excitation light emitted by the laser 504 is also scattered from the sample, as indicated by dashed arrows 524, and any excitation light scattered back through the objective lens or lenses 510 is reflected from the surface of the dichroic minor or absorbed by the emission filter 518. FIG. 5 also shows a representation of an oblique-illumination system 526 attached to the objective, as described above, and connected to an oblique illumination control 528. The control 528 can include a processor and can be connected to a motor, such as the motor 402 described above with reference to FIG. 4B, to axially positions the light-ring housing with respect to the sleeve of the illumination system 526. The processor also controls the pattern of lights in the light-ring housing used to illuminate the substrate 514.

FIGS. 6A-6B show front views of a light-ring housing with two different sets of oblique-illumination lights turned “on” at different times to provide oblique illumination of a substrate from two different directions. In FIG. 6A, a first set of three adjacent oblique-illumination lights 601-603 are turned “on” while the other oblique-illumination lights are turned “off,” and in FIG. 6B, a second set of three adjacent oblique-illumination lights 604-606 are turned “on” while the other lights are turned “off” to obliquely illuminate the same substrate from a different direction. FIG. 6C shows a perspective view of an oblique-illumination system 608 with four adjacent oblique-illumination lights 610-613 turned “on” to illuminate a substrate 614 from a particular direction. Use of the illumination system 608 is not limited to turning “on” adjacent lights. Any pattern and number of oblique-illumination lights can be selected to illuminate the substrate.

Returning to FIG. 5, the light emanating from a selection of oblique-illumination lights of the system 526 illuminates the sample and substrate from a direction represented by dashed arrow 530. The light is scattered from the surface of the substrate 514, as indicated by dotted arrow 532, and any light scattered from the surface of the substrate 514 through the objective lens or lenses 510 passes through the dichroic minor 508, emission filter 518, and ocular 520 to the detector 522, as indicated by solid arrow 534.

Ideally, each oblique-illumination light emits light with an oblique-illumination angle so that the light is outside the epi-illumination cone of the objective. FIGS. 7A-7B show cross-sectional views of a light-ring housing 702 of an oblique-illumination system and an objective 704 of an epi-fluorescence microscope. In FIG. 7A, dashed lines 706 represent limits of an epi-illumination cone associated with the objective 704. The epi-illumination cone defines a region of space in which the excitation light impinges on the sample and light emitted from fluorophores attached to the targets enter the objective 704. The epi-illumination cone angle θ is the half-angle of the maximum cone of light that can enter and exit the objective 704 and is determined by:

$$θ = {sin}^{- 1} \frac{NA}{n}$$

where NA is the numerical aperture, and
n is the refractive index of the medium in which the objective is working.

For example, n=1.0 for air, n=1.33 for distilled water, and n=1.56 for certain oils. As shown in FIG. 7A, the light output from each oblique-illumination light is focused so that the light strikes the sample within a range of oblique-illumination angles represented by φ, where φ+θ=90°. The range of oblique-illumination angles is outside the epi-illumination cone angle. In FIG. 7B, dot-dash directional arrows 708 and 710 represent a ray of excitation light that impinges on a fluorescently tagged target 712 and a ray of light emitted from the target, respectively. The rays 708 and 710 lie within the epi-illumination cone defined by dashed lines 706. Dashed lines 714 and 716 represent two oblique-illumination rays emanating from light source 718 and focused by lens 720 to strike the surface of a substrate 722 outside of the epi-illumination cone. The cross-sectional view of the substrate 722 reveals that the substrate is patterned with a number of protrusions 724. Rays that strike edges of the substrate 722 are reflected into the objective 704, while rays that strike flat surfaces of the substrate 722 are not reflected into the object 704. For example, as shown in FIG. 7B, ray 714 strikes an edge of a protrusion to produces a reflected ray, represented by dashed line 726, that is reflected into the objective 704. By contrast, ray 716 strikes a flat surface of the substrate 722 to produce a reflected ray, represented by dashed line 728, that is not reflected into the objective 704.

The surface of a substrate can be textured with a particular pattern to facilitate determination of target locations within a sample. FIG. 8 shows an example of a substrate 802 with a grid of perpendicular raised ridges 804 separating flat surfaces 806 of the substrate. A sample containing a number of fluorescently tagged targets can be disposed on the substrate 802. The sample can be a biological sample containing a number of fluorescently tagged cells. Images of the substrate 802 are obtained using an oblique-illumination system attached to the microscope objective and images of the targets of the sample can be obtained using epi-illumination as described above. Several different images of the substrate 802 can be obtained for a number of oblique-illumination angles using white light sources with each image of the substrate obtained by using a different set of lights in the light-ring housing of the illumination system. In a separate image capturing step, epi-illumination can be used to capture an image 808 of the targets and combined with an image of the substrate to produce a combined image 810 where of the location of each fluorescing target can be determined with respect to the ridges. Alternatively, while the substrate is being illuminated by the oblique-illumination system, epi-illumination can simultaneously be used to illuminate the fluorescently tagged targets so that the illuminated substrate and fluorescing targets are captured simultaneously to produce image 810.

A fluorescence microscope with an oblique-illumination system can be used to illuminate an object in a tube while a region between the object and the wall of the tube is illuminated with excitation light to detect fluorescently tagged targets located between the object and the wall of the tube. FIG. 9 shows an example of a tube 902 with a cylindrical object 904 that floats within a sample solution 906 in the tube 902. FIG. 9 also shows an oblique-illumination system 908 attached to a fluorescence microscope objective 910. Light emitted from a number of selected oblique-illumination lights of light-ring housing is used to illuminate regions of the tube 902 from different directions. Light reflected from the outer surface of the object 904 and captured through the objective 910 can be used to confirm the location of the object 904. Note that the object 904 may include a pattern of ridges that when illuminated from a particular direction confirms the location of the object 904. Once the position of the object 904 in the tube 902 has been determined, the region between the tube 902 and the object 904 and the wall of the float can be illuminated with excitation light to detect the presence of tagged targets and determine the location of tagged targets for further analysis.

FIG. 10 shows two actual images 1001 and 1002 of a cylindrical object floating in a tube using an oblique-illumination system. Each image was obtained through a microscope objective of the same fluorescence microscope with the illumination system attached to the objective as described above. The object includes raised ridges that extend parallel to the cylindrical axis of the object, which is identified by directional arrow 1003. The ridges are radially spaced around the cylindrical surface of the object, which is identified by directional arrow 1004. Dark regions of images 1001 and 1002 represent smooth surfaces of the object from which light was not reflected into the objective. By contrast, white spots on the images 1001 and 1002 represent light reflected from rough surfaces or edges into the objective. In order to obtain the image 1001, the oblique-illumination system was operated so that light struck the object substantially perpendicular to the orientation of the ridges, as represented by directional arrow 1006. The pattern of white spots in the image 1001 extending in the direction 1003 provides a clear representation of the orientation and locations the ridges. On the other hand, in order to obtain image 1002, the oblique-illumination system was operated so that light struck the object substantially parallel to the orientation of the ridges, as indicated by directional arrow 1008. The pattern of white spots cannot be used to identify the object. However, the image 1002 potentially reveals other features of the object, such as three ridges or cuts in the object as indicated by lines 1010-1012, which are not present in the image 1001, and image 1002 shows white patches which may reveal other uneven features of the object.

At least one of the lights in the light-ring housing may also be used to provide excitation light for fluorescently tagged targets of a sample solution. FIG. 11 shows the optical path within a fluorescence microscope where the excitation light is provided by excitation-light sources in the oblique-illumination system. Excitation light 1102 and 1104 is emitted from two excitation-light sources of an oblique-illumination system 1106. The excitation-light sources can be semiconductor lasers, as described above. The holes in which the excitation-light sources are located may include excitation filters located between the light source and the lens to select the wavelength of excitation light emitted from the light source. The excitation light causes fluorophores attached to targets within a sample 1107 to emit fluorescent light, as discussed above. The emitted fluorescent light, shown in FIG. 11 by dot-dash arrows 1108, passes through the objective lens or lenses 1110, passes through an emission filter 1112 and ocular 1114 to the image plane of a detector 1116. The excitation light emitted by the light source is scattered from the sample, as indicated by dashed arrows 1118, and any excitation light scattered back through the objective lens or lenses 1110 is absorbed by the emission filter 1112. FIG. 11 also shows the oblique-illumination system 1106 attached to the objective 1110, as described above, and connected to an oblique illumination control 1120. The control 1120 can include a processor and an actuator that axially positions the light-ring housing with respect to the sleeve of the illumination system 1106. The processor also controls the pattern of lights in the light-ring housing used to illuminate the target and the surface of a substrate 1122.

FIG. 12A shows a front view of a light-ring housing 1200 with four excitation-light sources as represented by dotted circles 1201-1204 and the remaining lights, represented by solid circles, such as circles 1206, are oblique-illumination light. FIGS. 12B-12C represent example of different lights turned “on” at different times to provide excitation light and oblique illumination. In FIG. 12B, the excitation-light source 1203 is turned “on” to emit excitation light of a particular wavelength and oblique-illumination lights 1208 are turned “on” while the other oblique-illumination lights and excitation-light sources are turned “off.” In FIG. 12C, excitation-light source 1201 is also turned “on” to illuminate a second type of fluorophore and three adjacent oblique-illumination lights 1210 are turned “on” while the other oblique-illumination lights and excitation-light sources are turned “off.” FIG. 12D shows a perspective view of an oblique-illumination system 1212 with three adjacent oblique-illumination lights 1214-1216 turned “on” to illuminate a substrate 1218 from a particular direction and an excitation-light source 1220 illuminated to excite fluorescently tagged target in a sample 1222.

Returning to FIG. 11, the light emanating from a selection of oblique-illumination lights in the illumination system 1106 illuminates the sample 1107 and substrate 1122 from a direction represented by dashed arrow 1124. The light is scattered from the surface of the substrate 1122, as indicated by dotted arrow 1126, and any light scattered from the surface of the substrate 112 through the objective lens or lenses 1110 passes through the emission filter 1112, and ocular 1114 to the detector 1116, as indicated by solid arrow 1128.

FIG. 13 shows a cross-sectional view of a light-ring housing 1302 of an oblique-illumination system and an objective 1304 of a fluorescence microscope. This cross-sectional view reveals an excitation-light source and oblique-illumination light source in the housing 1302. The excitation-light source includes a laser 1306, such as semiconductor laser, an excitation filter 1308, and a lens 1310 positioned to focus the light output from the filter on a sample 1312 disposed on a substrate 1314. The oblique-illumination light source includes a light source 1316, such as an LED or laser, and a lens 1318 as described above. Dot-dash directional arrow 1320 represents a ray of excitation light that excites a fluorescently tagged target 1322 and dot-dash directional arrow 1324 represents a ray of light emitted from the target. The ray 1324 lies within the epi-illumination cone of the objective 1304. Dashed lines 1326 and 1328 represent oblique-illumination rays that strike the surface of the substrate 1314 outside of the epi-illumination cone. The cross-sectional view of the substrate 1314 reveals that the substrate is patterned with a number of protrusions 1330. Rays that strike edges of the substrate 1314 are reflected into the objective 1304, while rays that strike flat surfaces of the substrate 1314 are not reflected into the object 1304. For example, as shown in FIG. 13, ray 1326 strikes an edge of a protrusion to produces a reflected ray 1330 that is reflected into the objective 1304. By contrast, ray 1328 strikes a flat surface of the substrate 1314 to produce a reflected ray 1332 that is not reflected into the objective 1304.

Although systems and methods have been described in terms of particular embodiments, it is not intended that this disclosure be limited only to these embodiments. For example, rather than embedding the light sources within the light-ring housing, as described above with reference to FIG. 4A, the light sources can be located outside the housing and the light can be guided into the housing optical fibers. The light sources can be used to provide oblique illumination outside the epi-illumination cone of the objective or the light sources can be used to supply excitation light. FIG. 14A shows a cross-sectional view of an oblique-illumination system with two light sources 1402 and 1404 located outside the housing 102. In the example of FIG. 14A, each light source is optically coupled to an optical fiber using a fiber optic coupler (not shown). Each optical fiber is located within one pair of aligned openings of the sleeve 104 and the housing 102 and terminates behind a lens. For example, a first optical fiber 1406 has a first end coupled to the source 1402 and a second end that terminates behind the lens 212, and a second optical fiber 1408 has a first end coupled to the source 1404 and a second end that terminates behind the lens 220. Although only two sources and two corresponding optical fibers are represented in FIG. 14A, FIG. 14A represents the case where each lens in the ring of lenses is illuminated by a corresponding separate light source. In alternative embodiments, one or more star couplers can be used to couple one light source to a number of optical fibers. FIG. 14B shows a cross-sectional view of an oblique-illumination system with one source 1410 coupled to a star coupler 1412 located outside the housing 102. The source 1410 is coupled to the star coupler 1412 input port and the first ends of the two optical fibers 1406 and 1408 are coupled to two outputs ports of the coupler 1412. The coupler 1412 splits the light output from the source 1410 into the two optical fibers 1406 and 1408. Star couplers can be configured to split the light output from a single source into more than two output ports. As a result, a single star coupler can be used to split the light output from a single source into at least two optical fibers that each leads to one of the lenses in the housing. For example, a 1:4 star coupler can be used to split the light received from a single source into four separate optical fibers that leads to four adjacent lenses in the housing to illuminate as sample from a particular direction, as shown in FIG. 6C.

In alternative embodiments, rather that configuring the housing 102 with separate lenses for each light source, a housing may have a single ring-shaped lens that directs light output from each opening in the housing onto a sample outside the epi-illumination cone of an objective. FIGS. 15A-15B show perspective views of a housing 1502 that is similar to the housing 102 except the individual lenses 124 of the housing 102 have been replaced by a single ring-shaped lens 1504. As shown in FIG. 15A, the ring-shaped lens is curved so that light to emanate from a ring of holes located behind the lens 1504 is directed outside the epi-illumination cone of an objective inserted into the opening 1506 of the housing 1502. FIG. 15B shows an exploded view with the ring-shaped lens 1502 separate from the housing 1502 to reveal the ring of axially-oriented, radially spaced holes around the opening 1506.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the following claims and their equivalents.

What is claimed is:

1. An oblique-illumination system comprising a light-ring housing, wherein the light-ring housing includes a cylindrical opening to receive a portion of a microscope objective and a number of addressable oblique-illumination lights positioned around the opening to provide illumination at angles outside an illumination cone of the objective.

2. The system of claim 1, further comprising a sleeve with a cylindrical opening to receive a second portion of the microscope objective.

3. The system of claim 2, wherein cylindrical axes of the cylindrical openings of the housing and the sleeve are aligned with the objective optical axis of the objective and a front lens assembly of the objective is exposed through the opening in the housing.

4. The system of claim 2, wherein the sleeve includes a number of guides separated by grooves in the outer surface of the sleeve, and wherein the housing includes a cylindrical shell with a number of guides separated by grooves around the cylindrical shell inner surface such that a portion of the sleeve is to be inserted in the cylindrical shell with the guides and grooves of the sleeve to interlock with the grooves and guides of the cylindrical shell.

5. The system of claim 2, wherein the sleeve includes a number of radially-spaced, axially-oriented openings surrounding the opening in the sleeve, each opening aligned with one of the oblique-illumination lights.

6. The system of claim 1, wherein the housing includes a number of radially-spaced, axially-oriented openings surrounding the opening in the housing such that each oblique-illumination light is disposed within one of the openings to direct light output from light source outside the illumination cone of the objective.

7. The system of claim 1, wherein the housing includes:
a number of radially-spaced, axially-oriented openings surrounding the opening in the housing; and
a ring-shaped lens positioned in front of the openings to direct light output from each of the oblique-illumination lights outside the illumination cone of the objective.

8. The system of claim 1, wherein each oblique-illumination light includes a light source located within one of a number of radially-spaced, axially-oriented openings surrounding the opening in the housing.

9. The system of claim 1, wherein the oblique-illumination lights include:
at least one light source located outside the housing; and
a number of optical fibers, wherein a portion of each optical fiber is located within one of a number of radially-spaced, axially-oriented openings surrounding the opening in the housing and is optically coupled at a first end to one of the light sources to emit light from a second end of the fiber outside the illumination cone of the objective.

10. A fluorescence microscope comprising:
a source of excitation light;
a detector including an image plane;
a microscope objective to direct the excitation light onto a sample solution containing fluorescently tagged targets and direct a portion of light emitted from the targets within the objective epi-illumination cone to the image plane; and
an optical-illumination system attached to the objective, the system to illuminate features of a surface upon which the sample is disposed outside the epi-illumination cone and the objective to direct a portion of the light scattered from surface features to the image plane.

11. The microscope of claim 10, wherein the oblique-illumination system comprises a light-ring housing, wherein the light-ring housing includes a cylindrical opening to receive a portion of a microscope objective and a number of addressable oblique-illumination light sources positioned around the opening to provide illumination at angles outside an illumination cone of the objective.

12. The microscope of claim 11, further comprising a sleeve with a cylindrical opening to receive a second portion of the microscope objective.

13. The microscope of claim 12, wherein cylindrical axes of the cylindrical openings of the housing and the sleeve are aligned with the objective optical axis of the objective and a front lens assembly of the objective is exposed through the opening in the housing.

14. The microscope of claim 12, wherein the sleeve includes a number of guides separated by grooves in the outer surface of the sleeve, and wherein the housing includes a cylindrical shell with a number of guides separated by grooves around the cylindrical shell inner surface such that a portion of the sleeve is to be inserted in the cylindrical shell with the guides and grooves of the sleeve to interlock with the grooves and guides of the cylindrical shell.

15. The microscope of claim 12, wherein the sleeve includes a number of radially-spaced, axially-oriented openings surrounding the opening in the sleeve, each opening aligned with one of the oblique-illumination lights to provide an electrical connection.

16. The microscope of claim 12, wherein the housing includes a number of radially-spaced, axially-oriented openings surrounding the opening in the housing such that each oblique-illumination light is disposed within one of the openings to direct light output from light source outside the illumination cone of the objective.

17. The microscope of claim 12, wherein the housing includes:
a number of radially-spaced, axially-oriented openings surrounding the opening in the housing; and
a ring-shaped lens positioned in front of the openings to direct light output from each of the oblique-illumination lights outside the illumination cone of the objective.

18. The microscope of claim 12, wherein each oblique-illumination light includes a light source located within one of a number of radially-spaced, axially-oriented openings surrounding the opening in the housing.

19. The microscope of claim 12, wherein the oblique-illumination lights include:
at least one light source located outside the housing; and
a number of optical fibers, wherein a portion of each optical fiber is located within one of a number of radially-spaced, axially-oriented openings surrounding the opening in the housing and is optically coupled at a first end to one of the light sources to emit light from a second end of the fiber outside the illumination cone of the objective.

20. A method comprising:
illuminating a sample solution containing fluorescently tagged targets with excitation light;
collecting a portion of light emitted from targets in an epi-illumination cone of an objective to direct the emitted light to an image plane of a detector;
illuminating a substrate upon which the sample solution is disposed from an oblique-illumination angle outside of the epi-illumination cone;
collecting a portion of the light scattered from features of the substrate with the objective to direct to the scattered light to the image plane; and
determining target locations based on based on the locations of the surface features.

21. The method of claim 20, wherein illuminating the substrate further comprises illuminating the substrate from a selected direction.

22. The method of claim 21, further comprising forming at least one image of the substrate features associated with each illumination direction.

23. The method of claim 20, wherein illuminating the substrate further comprises illuminating the substrate with light produced by an oblique-illumination system attached to the objective.

24. The method of claim 20, further comprising forming at least one image of the fluorescent target and the substrate.
